(19) United States
(12) Patent Application Publication
(10) Pub. No.: US 2009/0288031 A1
(43) Pub. Date: Nov. 19, 2009

(54) TIME BLOCK PLANNING

(75) Inventors: John Solaro, Bellevue, WA (US); Kathleen P. Mulcahy, Seattle, WA (US); Robert S. Dietz, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/122,651

(22) Filed: May 16, 2008

(51) Int. Cl. G06F 9/46; G06F 3/048

(52) U.S. Cl. 715/772; 718/107; 718/103

(57) ABSTRACT

A system, method and apparatus for time block planning is disclosed. For example, one disclosed embodiment comprises receiving a first task with a set start time and a set duration, receiving a second task with a flexible start time, and scheduling the first task at the set start time and for the set duration. Next, the embodiment comprises scheduling the second task if the second task does not temporally overlap the first task, otherwise scheduling the second task at a different time or placing the second task in a user input queue if the second task temporally overlaps the first task. Additionally, this embodiment comprises displaying a schedule with a graphical user interface and prompting a response to the second task in the user input queue. In this way, a second task can be scheduled at a different time according to a response to the user input queue.

### BACKGROUND

Computer based calendar systems allow a user to input various tasks to create a schedule. These computer based calendaring systems generate reminders about events and may be coupled with email programs or other applications or tools to coordinate schedules for multiple users, send reminders, schedule meeting times, etc. Additionally, calendar systems may record and schedule various tasks that do not overlap in time, and in the event the tasks do overlap, the calendar systems schedule multiple tasks at a given time.

Computer based calendar systems therefore integrate tasks into a schedule in a rigid manner that is not always suitable for planning a varied schedule. For example, users, workers, students, etc., may have set time commitments for certain events, such as classes and extracurricular activities, but these approaches do not work well for scheduling events of unclear duration and events based on start or end times, which both may require estimating how much time it takes to complete an event. Additionally, workers, students, users, etc. may need to make time for tasks that do not have designated start or end times, but should happen at a specified frequency and duration such as eating, exercising, relaxing, or spending time with friends.

### SUMMARY

Accordingly, various embodiments for time block planning are described below in the Detailed Description. For example, one embodiment comprises receiving a first task with a set start time and a set duration, receiving a second task with a flexible start time and a set duration or a flexible duration, and scheduling the first task at the set start time and for the set duration. Next, the embodiment comprises scheduling the second task if the second task does not temporally overlap the first task, scheduling the second task at a different time if possible, otherwise placing the second task in a user input queue. Additionally, this embodiment comprises displaying a schedule with a graphical user interface and prompting a response to the second task in the user input queue. In this way, a second task can be scheduled at a different time when possible, and a user can resolve remaining scheduling issues using the user input queue.

This Summary is provided to introduce concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic drawing illustrating a system for scheduling tasks according to the start time of the task.

FIG. 2 is a high-level overview of a method of student coursework and activity planning using the system depicted in FIG. 1.

FIG. 3 is an example of a schedule generated by the method depicted in FIG. 2.

FIG. 4 is a bar graph illustrating a workload corresponding to the schedule illustrated in FIG. 3.

FIG. 5 is a high-level flowchart of a method of further scheduling tasks according to a priority associated with the task.

### DETAILED DESCRIPTION

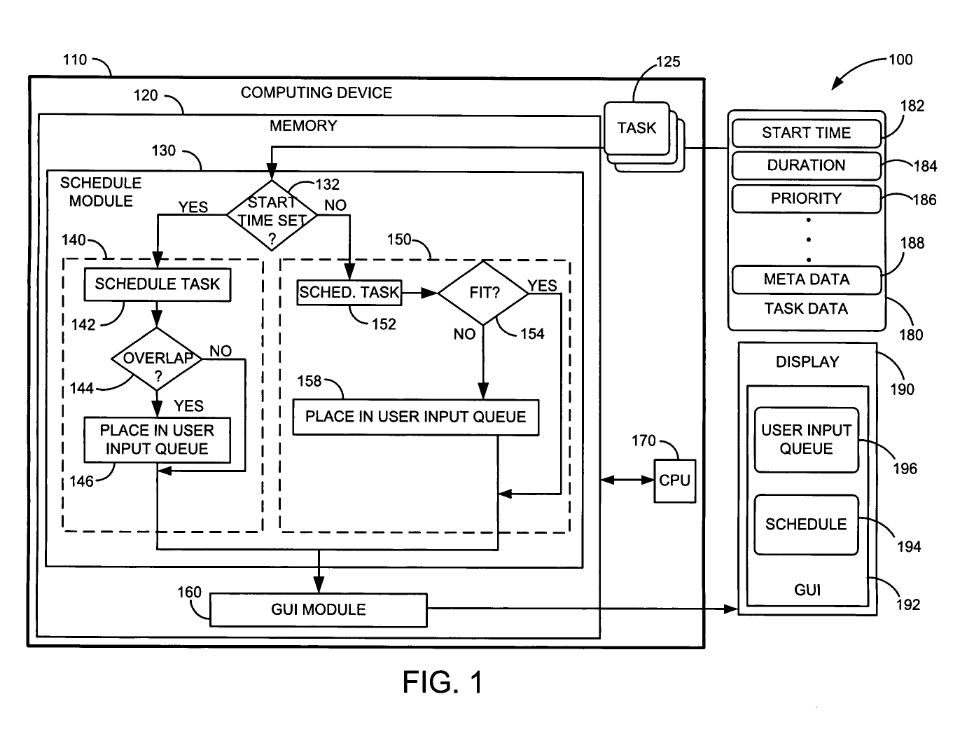

FIG. 1 is a schematic drawing illustrating a scheduling system 100 for generating a suggested schedule 194 according to tasks 125 with varied scheduling constraints. The scheduling system 100 may include a computing device 110 including a memory 120, a CPU 170, and a schedule module 130 stored in memory 120. Schedule module 130 may further include a fixed start time module 140 and a flexible start time module 150, and the computing device 110 may further include a graphical user interface controller, for example GUI module 160, to control a GUI 192 to display a schedule 194 in a connected display 190. Scheduling system 100 may also provide a user input queue 196 to alert a user of a scheduling conflict between multiple tasks and in turn allow a user input to resolve the scheduling conflict.

In some embodiments, computing device 110 is configured to receive as an input one or more tasks 125 in the form of task data 180, wherein the task data may be of different categories of data with each category having unique scheduling constraints. For example, task data 180 may include data associated with a plurality of tasks. In some embodiments, schedule module 130 may receive tasks 125 from a database, and schedule the tasks 125 according to task specific scheduling constraints. Task data 180 may include data related to a start time 182 for a task, a duration 184 for a task, a priority 186 for a task, other metadata 188 associated with a task, as non-limiting examples. Further, example tasks 125 may include data related to a due date, severability of a task, recurrence of a task, dependency of a task on another task, and other restrictions associated with a task. Additionally, some tasks 125 may be tasks that were already scheduled and not completed. In this way, an incomplete task that is past an initially scheduled time may be processed by scheduling system 100 and incorporated into a suggested schedule.

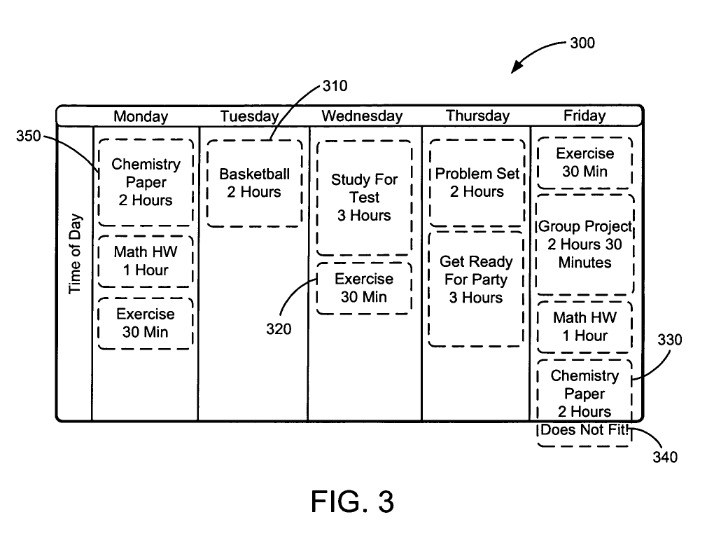

In one example, schedule module 130 may be configured to receive multiple tasks 125 including at least a first task with a set start time and a set duration and a second task with a flexible start time and a set duration or a flexible duration. With reference to FIG. 3, schedule module 130 may be used by a student to schedule classes, study time, workouts, a homework assignment, extracurricular activities, etc. For example, schedule module 130 may receive a first task with a set start time and a set duration such as a group project, a second task with a flexible start time such as a 30 minute exercise session, a third task with a set start time and a low priority such as a television show (not shown), etc., wherein the schedule module 130 may then generate a suggested schedule 194 including these and other tasks according to the varying scheduling constraints of each of the tasks 125.

Referring back to FIG. 1, schedule module 130, fixed start time module 140, and flexible start time module 150 will be explained in more detail. When a task is received, start time decision block 132 forwards the task to fixed start time module 140 and flexible start time module 150 according to tasks 125 that have a set start time and tasks that have a flexible start time. If a first task having a set start time is passed to fixed start time module 140, the schedule task block 142 will then schedule the first task at the set start time. Then, in overlap decision block 144, the fixed start time module 140 determines if the first task temporally overlaps a previously scheduled task, and if the first task does not temporally overlap a previously schedule task, the first task may be entered into a suggested schedule 194. The first task or an entire suggested schedule may then be passed to GUI module 160 to provide it in the proper format for display 190 to display in GUI 192. However, if there is a temporal overlap between the first task and a previously scheduled task, fixed start time module 140 will place the first task in user input queue in block 146, and pass the task to GUI module 160 to provide the task in the proper format for display 190 to display in the user input queue 196 in GUI 192.

When a task with a flexible start time is received in schedule module 130, the second task is passed from start time decision block 132 to flexible start time module 150 and is scheduled at schedule task block 152. For example, schedule task block 152 may be configured to schedule the flexible start time task at the first time it fits within a schedule. Other embodiments may provide more detailed selections for scheduling a flexible start time task. For example, a user may specify a start of the day or an end of the day preference, and the schedule task block 152 may then search for an opening within a schedule that satisfies the preference. Then, in decision block 154 the flexible start time module 150 may determine if the second task fits in the suggested schedule, and if so, passes schedule information to GUI module 160 to format the second task for display in GUI 192. In the event the second task does not fit in the suggested schedule, flexible start time module 150 places the second task in the user input queue in functional block 158.

In some embodiments, the schedule module 130 may receive additional tasks and schedule those tasks according to a scheduling algorithm using fixed start time module 140 and flexible start time module 150. Schedule module 130 may receive a third or subsequent task having a flexible start time or having a set start time with a set duration. For example, if one of the second task or the third task has a higher priority than the other, then schedule module 130 will schedule the one of a second task or the third task according to the priority associated with each of the tasks. Then, schedule module 130 may schedule the remaining second task or third task at a time that does not temporally overlap any previously scheduled task. If the remaining second task or third task temporally overlaps any previously scheduled task, scheduling module 130 will place the remaining second task or third task in the user input queue 196 in GUI 192. In some embodiments, the GUI 192 may be further configured to display a graphical representation, a chart, a bar graph, etc., of the schedule 194 and any remaining tasks in the user input queue 196 to alert a user of a scheduling conflict between multiple tasks and in turn allow a user input to resolve the scheduling conflict.

In some embodiments, the schedule module 130 may receive task data 180 in the form of metadata 188 that includes constraints of one or more of a duration, a due date, a severability, a recurrence, a dependency, and a restriction associated with a task. When schedule module 130 receives metadata 188, it schedules a task according to the constraints defined by the metadata. Alternately, if there is a conflict in the metadata 188, schedule module 130 places the task in the user input queue. In this regard, schedule module 130 provides a multi-layered approach according to constraints in the metadata in addition to other scheduling constraints enumerated in examples described in reference to FIG. 1 above.

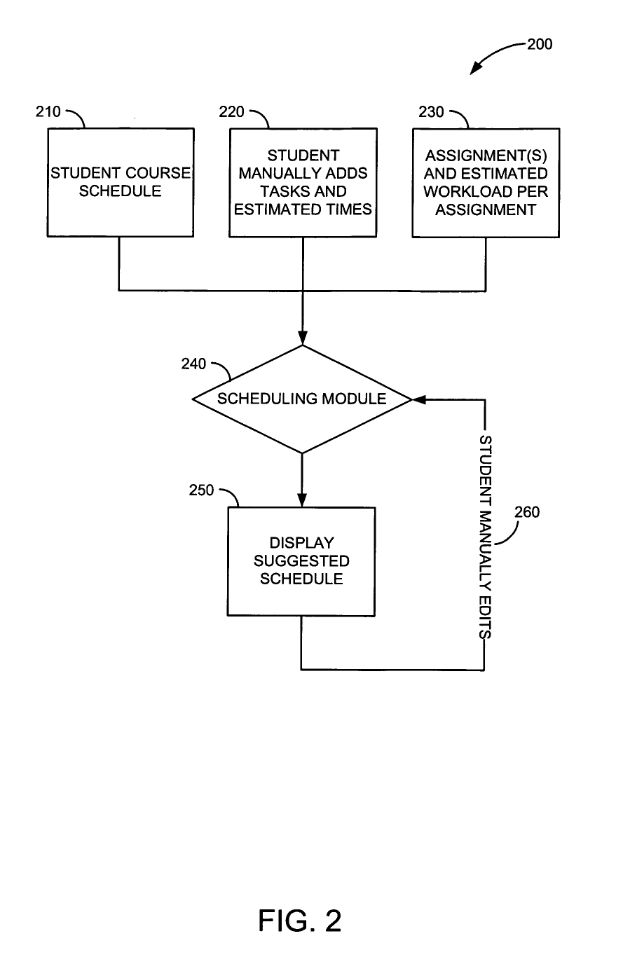

FIG. 2 illustrates an embodiment comprising a student coursework and activity planning method 200. Planning method 200 includes a student course schedule input 210, a student task data input 220, and an estimated workload input 230. For example, the estimated workload input 230 may include assignments associated with one or more courses and an estimated workload for each assignment. Course schedule input 210 may include course schedule data received directly from a student, from an educational institution, from a registrar or an instructor or a plurality of instructors, from a database, etc. For example, the course schedule may include information related to specific courses, including data related to task priority, recurrence, start time, duration, etc., or other data as explained with reference to the embodiment illustrated in FIG. 1.

In some embodiments, student task data input 220 may include receiving tasks manually added by a student. For example, a student might enter an activity, e.g. basketball practice, along with data associated with those activities, e.g., an estimated time for the basketball practice. In another example, student task data input 220 may receive information about an incomplete task from the student at the end of a first time period such as a previously scheduled day or week including the task. In this way, the incomplete task may be incorporated or rolled over into a future date in the schedule.

In some embodiments, estimated workload input 230 may be task data information related to one or more homework assignments from instructors, other students, a manual input, a network, a database, etc. For example, the information may be how long it took other students to complete the homework assignment, an estimated homework assignment difficulty, an estimated time needed to complete the assignment, or other constraints representable with metadata and associated with that particular homework assignment or task. In this way, a student may review the estimated workload input 230 and estimate the time needed to complete the homework assignment, etc.

Next, student coursework and activity planning method 200 passes information from course schedule input 210, student task data input 220, and estimated workload input 230 to scheduling module 240 to generate a suggested schedule. Next, planning method 200 displays a suggested schedule in display suggested schedule block 250. For example, display suggested schedule block 250 may display a graphical representation of the suggested schedule and any related tasks in the GUI 192. In some embodiments, GUI 192 includes drag and drop objects or resizable objects to allow a user to adjust tasks in suggested schedule 194.

In one example, scheduling module 240 may receive a first task with a set start time and a set duration and a second task with a flexible start time. Then, scheduling module 240 may schedule the first task at the set start time and for the set duration and schedule the second task if the second task does not temporally overlap the first task. In the event the second task temporally overlaps the first task, scheduling module 240 may schedule the second task at a different time than the first task and place the second task in a user input queue. Additionally, scheduling module 240 may provide a suggested schedule to display suggested schedule block 250, wherein the suggested schedule may be displayed through a graphical user interface. In some embodiments, planning method 200 may prompt a response to conflicting tasks in the user input queue, and resolve conflicts by changing metadata for at least one of those tasks, for example, to be at a different time or a different duration according to a response to the user input queue.

In some embodiments, scheduling module 240 may receive and schedule additional tasks. For example, scheduling module 240 may receive a third task having either a flexible start time or a set start time with a set duration and schedule one of a second task or the third task according to a priority associated with each of the second task and the third task. Scheduling module 240 may then schedule the remaining second task or third task at a time that does not temporally overlap a previously scheduled task, or place the remaining second task or third task in a user input queue to alert a user of a scheduling conflict between multiple tasks and in turn allow a user input to resolve the scheduling conflict.

In yet another embodiment, scheduling module 240 may receive metadata including one or more of a duration, a due date, a severability, a recurrence, a dependency, and a restriction associated with each task, and schedule each task according to the metadata. In this way, if scheduling module 240 detects a schedule conflict according to the metadata, it places the task in the user input queue. In an example, scheduling module 240 may receive one or more homework assignments from a database and schedule the homework assignments as a task with a flexible start time. Metadata associated with the one or more homework assignments may include a set duration for the homework assignment estimated at least in part by a previous homework assignment duration from other students in the class, from previous homework assignment durations for the same student in the same class, etc.

In this way, scheduling module 240 may schedule a plurality of tasks to achieve a preferred workload throughout a schedule and output the suggested schedule to display suggested schedule block 250. At edit loop 260, a student may respond to any tasks in the user input queue. For example, the student may manually edit the suggested schedule and pass the edit back to scheduling module 240, which may rearrange the schedule.

FIG. 3 illustrates an example suggested schedule 300 generated by the planning method 200 depicted in FIG. 2. In some embodiments, suggested schedule 300 may be displayed in GUI 192. Schedule 300 is illustrated in a calendar format, with days arranged in columns, the time of day arranged in rows, and tasks depicted as schedule blocks. For example, a user may have a basketball practice 310 with a set start time and a set duration that recurs every Tuesday. The schedule 300 may also display activities with a flexible start time. For example, exercise activity 320 and homework related to chemistry paper 330 may each have a flexible start time. Homework related to chemistry paper 330 may include metadata associated with the assignment. In this example, the schedule 300 depicts the chemistry paper 330 does not fit within the schedule with the Does Not Fit! 340 warning message. The student may then respond through a user input queue or an edit loop and schedule the chemistry paper 330 for a different time. For example, chemistry paper 350 may represent a suggested alternate time for the assignment. In an alternate example, the user input queue may provide an option to break the two hour chemistry paper 330 into separate one hour blocks in order to fit available time slots in an existing schedule.

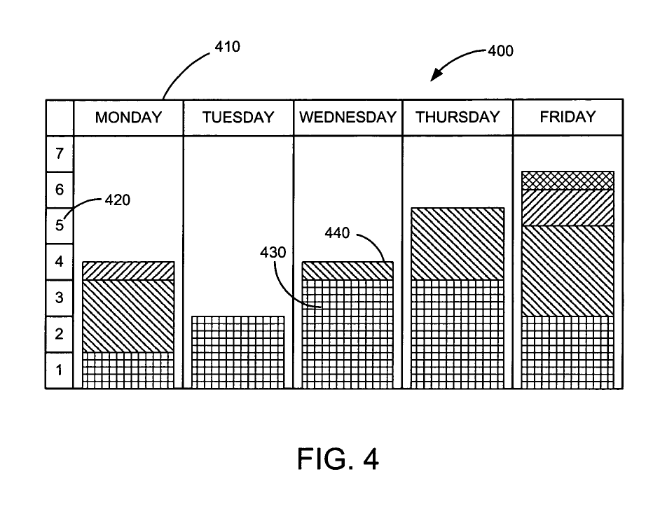

Referring now to FIG. 4, a bar graph 400 may be used to display the distribution of the student's workload corresponding to the schedule illustrated in FIG. 3. For example, bar graph 400 includes days 410 and a representation of the student's workload 420 distributed across the days 410. Bar graph 400 may further display the workload 420 as individual tasks 440 and 430, such as a task with a set start time and set duration 430 and a task with a flexible start time 440, which may be depicted by different patterns, colors, etc. In this example, a user may be able to review the relative workload throughout the week. In some embodiments a user interface could also display daily, monthly, or other suitable user requested timeframes.

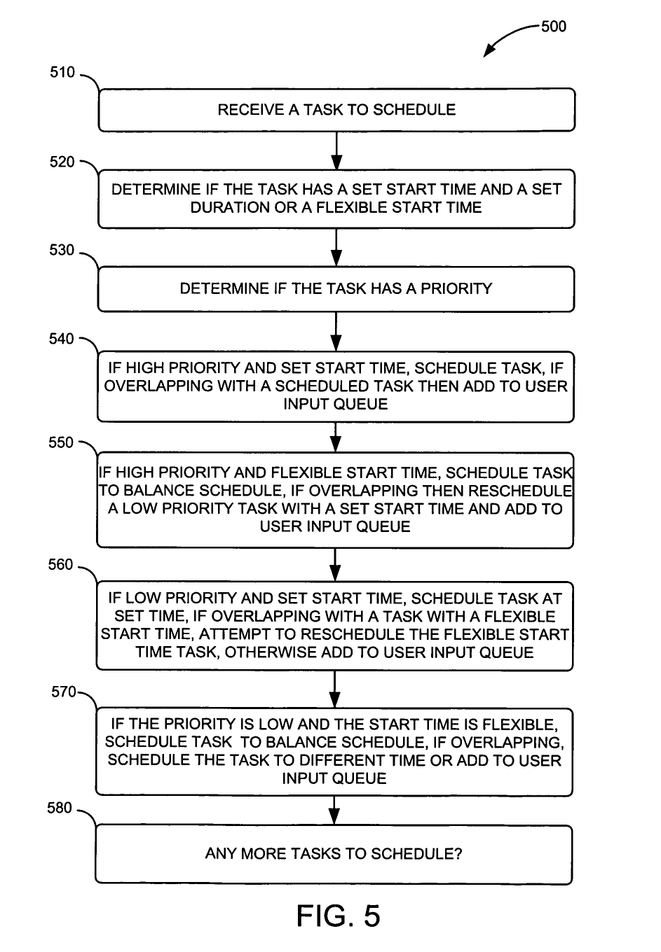

FIG. 5 illustrates a high-level flowchart of a method 500 of further scheduling tasks according to a priorities associated with each task. For example, schedule module 130 may receive first, second, and third tasks 125, wherein each task has an associated priority 186. Schedule module 130 may schedule the first task and then may choose a selected task from the second or third tasks according to the priority 186 of each of the second and third tasks. In this example, method 500 receives a task at block 510, and at block 520, checks to see whether the task has a set start time and a set duration or if the task has a flexible start time. At block 530, method 500 checks to see if the task has an associated priority 186. In this example, priority 186 may be one of two values, high or low. Alternately, priority 186 may be a value selected from a range of more than two values. At block 540 through block 570, method 500 checks the value of priority 186 and start time 182 associated with each of the tasks 125.

If priority 186 has a high value and start time 182 is set, a task may be scheduled at the set time at block 540. However, if there is a temporal overlap with a previously scheduled task, the task may be added to user input queue 196. In block 580, method 500 checks to see if there are more tasks to schedule.

Alternatively, if priority 186 has a high value and start time 182 is flexible, the routine may place the task to accommodate a user's preferred workload at block 550. For example, a user may prefer that tasks with a flexible start time are distributed throughout a weekly schedule to create a balanced workload. However, if there is a temporal overlap with a task having a set start time and a low priority, a previously scheduled task with a flexible start time and high priority may be moved or rescheduled so that the low priority task can start at the set time, and if any tasks remain unscheduled, the tasks may be added to the user input queue. In this example where priority 186 has a low value and start time 182 is set, the task may be placed at the set start time at block 560. If there is a temporal overlap with a higher priority task and the other task has a flexible start time, then the other task is moved to a different start time that fits. If it cannot be moved because there is no other start time that fits, or if the other task has a set start time, the task may be added to user input queue 196.

Finally, if priority 186 has a low value and start time 182 is flexible, at block 570 the task is placed according to the user's preferred workload scheme, for example, distributed throughout the week. If there is a temporal overlap with a previously scheduled task, the routine may reschedule this task to a different start time. Alternatively, the routine may reschedule a high priority task with a flexible start time.

Referring to scheduling system 100 in FIG. 1 and method 500 in FIG. 5, memory 120 may take the form of a computer-readable medium comprising instructions executable by computing device 110 to cache data from schedule module 130. For example, computing device 110 may receive a first task with a set start time and a set duration, a second task with a flexible start time. Schedule module 130 may then schedule the first task at the set start time and for the set duration, and schedule the second task if the second task does not temporally overlap the first task. Further, if the second task temporally overlaps the first task, schedule module 130 may schedule the second task at a different time, and if the second task could not be scheduled at a different time it may be placed in the user input queue. Further, in an embodiment having a second task that has a set start time in conflict with a first task, computing device 110 may display a schedule with a graphical user interface and prompt a response to the second task in the user input queue, whereby the user may schedule the second task at a different time even though the second task has a set start time.

It will be appreciated that the computing devices described herein may be any suitable computing device configured to execute the programs described herein. For example, the computing devices may be a mainframe computer, personal computer, laptop computer, portable data assistant (PDA), computer-enabled wireless Microsoft Corporation Page 12 telephone, networked computing device, or other suitable computing device, and may be connected to each other via computer networks, such as the Internet. These computing devices typically include a processor and associated volatile and non-volatile memory, and are configured to execute programs stored in non-volatile memory using portions of volatile memory and the processor. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that computer-readable media may be provided having program instructions stored thereon, which upon execution by a computing device, cause the computing device to execute the methods described above and cause operation of the systems described above.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A scheduling system with an input, a memory, and a processor in communication with the input and the memory, the scheduling system comprising:
a schedule module configured to receive at least a first task with a set start time and a set duration and a second task with a flexible start time, the schedule module including a fixed start time module configured to generate a schedule including the first task, and a flexible start time module configured to add the second task to the schedule, the flexible start time module further configured to schedule the second task at a different time from the first task or to place the second task in a user input queue; and
a graphical user interface configured to display the schedule, and further configured to display a prompt for a response to the user input queue, wherein the schedule module is further configured to schedule the second task based on a response to the user input queue.

2. The scheduling system of claim 1, wherein the schedule module is further configured to:
receive a third task having either a flexible start time or a set start time with a set duration;
schedule one of the second task or the third task according to a priority associated with each of the second task and the third task;
schedule a remaining second task or third task at a time that does not temporally overlap a previously scheduled task; and
place the remaining second task or third task in the user input queue if the remaining second task or third task does temporally overlap with a previously scheduled task.

3. The scheduling system of claim 1, wherein the schedule module is configured to receive metadata including one or more of a duration, a due date, a severability, a recurrence, a dependency, and a restriction associated with the first task or the second task, and to schedule at least one of the first task or the second task according to the metadata.

4. The scheduling system of claim 3, wherein in response to a schedule conflict for a task scheduled according to the metadata, the schedule module to place the task in the user input queue.

5. The scheduling system of claim 1, wherein the graphical user interface is further configured to display a graphical representation of the schedule and any tasks in the user input queue.

6. The scheduling system of claim 1, wherein the schedule module is further configured to: receive an assignment from a database; and
schedule the assignment as a task with a flexible start time.

7. A student coursework and activity planning method to create a schedule, the method comprising:
receiving a first task with a set start time and a set duration;
receiving a second task with a flexible start time;
scheduling the first task at the set start time and for the set duration;
scheduling the second task if the second task does not temporally overlap the first task;
scheduling the second task at a different time and placing the second task in a user input queue if the second task temporally overlaps the first task;
displaying a schedule with a graphical user interface;
prompting a response to the second task in the user input queue; and
scheduling the second task at a different time according to a response to the user input queue if the second task can be scheduled at a different time.

8. The method of claim 7, further comprising:
receiving a third task having either a flexible start time or a set start time with a set duration;
scheduling one of the second task or the third task according to a priority associated with each of the second task and the third task;
scheduling a remaining second task or third task at a time that does not temporally overlap a previously scheduled task; and
placing the remaining second task or third task in the user input queue if the remaining second task or third task does temporally overlap with a previously scheduled task.

9. The method of claim 7, further comprising:
receiving metadata including one or more of a duration, a due date, a severability, a recurrence, a dependency, and a restriction associated with each task; and
scheduling each task according to the metadata.

10. The method of claim 9, wherein in response to a schedule conflict for a task scheduled according to the metadata, the method further comprising placing the task in the user input queue.

11. The method of claim 7, further comprising displaying a graphical representation of the schedule and any tasks in the user input queue in the graphical user interface.

12. The method of claim 7, further comprising removing the second task from the schedule if the second task cannot be scheduled at a different time.

13. The method of claim 7, further comprising:
receiving one or more assignments from a database; and
scheduling the assignments as a task with a flexible start time.

14. The method of claim 13, wherein the assignment further comprises a set duration estimated at least in part by a previous assignment duration.

15. A computer-readable medium comprising instructions executable by a computing device to perform a method comprising:
receiving a first task with a set start time and a set duration;
receiving a second task with a flexible start time;
scheduling the first task at the set start time and for the set duration;
scheduling the second task if the second task does not temporally overlap the first task;
scheduling the second task at a different time and placing the second task in a user input queue if the second task temporally overlaps the first task;
displaying a schedule with a graphical user interface;
prompting a response to the second task in the user input queue; and
deleting or modifying the second task according to a response to the user input queue.

16. The computer-readable medium of claim 15 further comprising instructions for:
receiving a third task having either a flexible start time or a set start time with a set duration;
scheduling one of the second task or the third task according to a priority associated with each of the second task and the third task;
scheduling a remaining second task or third task at a time that does not temporally overlap a previously scheduled task; and
placing the remaining second task or third task in the user input queue if the remaining second task or third task does temporally overlap with a previously scheduled task.

17. The computer-readable medium of claim 15 further comprising instructions for:
receiving metadata including one or more of a duration, a due date, a severability, a recurrence, a dependency, and a restriction associated with each task; and
scheduling each task according to the metadata.

18. The computer-readable medium of claim 17, wherein in response to a schedule conflict for a task scheduled according to the metadata, the computer-readable medium further comprising instructions for placing the task in the user input queue.

19. The computer-readable medium of claim 15 further comprising instructions for displaying a graphical representation of the schedule and any tasks in the user input queue in the graphical user interface.

20. The computer-readable medium of claim 15 further comprising instructions for:
receiving one or more assignments from a database; and
scheduling the assignments as a task with a flexible start time.

21. The computer-readable medium of claim 16, further comprising:
rescheduling a previously scheduled task with a flexible start time; and
scheduling a subsequent lower priority task with a set start time at the original start time of the previously scheduled task.
